(19) United States
(12) Patent Application Publication
(10) Pub. No.: US 2012/0006633 A1
(43) Pub. Date: Jan. 12, 2012

(54) Vehicle Brake

(75) Inventor: Wolfgang PAHLE, Bad Wiessee (DE)

(73) Assignee: KNORR-BREMSE Systeme fuer Nutzfahrzeuge GmbH, Muenchen (DE)

(21) Appl. No.: 13/197,351

(22) Filed: Aug. 3, 2011

Related U.S. Application Data
(63) Continuation of application No. PCT/EP2010/000811, filed on Feb. 10, 2010.

(30) Foreign Application Priority Data
Feb. 11, 2009 (DE) 10 2009 008 341.3

(51) Int. Cl. F16D 66/00; F16D 65/04; F16D 49/00; F16D 51/00; F16D 65/092; F16D 55/22

(52) U.S. Cl. 188/72.1; 188/250 R; 188/73.1; 188/74

(57) ABSTRACT

A vehicle brake, in particular a disc brake or drum brake having pads or linings arranged on brake pad or lining carrier plates, and including an application device, is characterized in that at least one brake pad or lining of the vehicle brake is equipped with an electronic unit, which has an electronic memory for at least storing brake pad or lining specific data.

### CROSS-REFERENCE TO RELATED APPLICATIONS

This application is a continuation of PCT International Application No. PCT/EP2010/000811, filed Feb. 10, 2010, which claims priority under 35 U.S.C. §119 from German Patent Application No. DE 10 2009 008 341.3, filed Feb. 11, 2009, the entire disclosures of which are herein expressly incorporated by reference.

### BACKGROUND AND SUMMARY OF THE INVENTION

The invention relates to a vehicle brake, in particular a disc brake or drum brake having brake pads or linings fixed to brake pads or lining carrier plates, and comprising an application device.

Brake pads or linings of vehicles are parts subject to wear and as such have to be exchanged after a given quantity of wear has occurred. The manufacturers of commercial vehicles recommend that the vehicle operators respect particular requirements. One of these requirements is that all the brake pads or linings of a vehicle should have a uniform coefficient of friction. This requirement is frequently not observed, since not only brake pads or linings supplied by the manufacturer of the commercial vehicle are installed in workshops, but also those of manufacturers who supply brake pads of inferior quality. While the term “brake pads” is typically associated with a disc brake and the term “brake linings” is typically associated with a drum brake, the term “brake pad” will be used herein for convenience but should be broadly construed to also include brake linings of a vehicle drum brake.

It is the object of the invention to design a vehicle brake of the above-mentioned type in such a manner that it can be ascertained at least whether brake pads meeting the relevant safety requirements were fitted during an exchange, even if, after the exchange, the brake pads used were not brake pads approved by the manufacturer of the brake but were nevertheless approved through homologation by, for example, the German Federal Motor Transport Authority.

This and other objects are achieved by a vehicle brake, in particular a disc brake or drum brake having brake pads/linings fastened to brake pad/lining carrier plates and comprising an application device, wherein at least one brake pad or lining of the vehicle brake is equipped with an electronic unit, which is provided with an electronic memory, for storing at least brake pad-specific data.

The invention also creates a brake system with a vehicle brake, characterized by a design such that brake pad-specific data on the electronic unit of the brake pad can be processed by a control unit of the vehicle brake system, the data including brake pad specific parameters which influence the braking effect, such as the quality, lining area or coefficient of friction attained during manufacture. The direct utilization of pad-specific data therefore becomes very simple, significantly increasing the safety of the brake system since, for example, individual wheels can be activated differently if this is required by the pads, without the need to determine pad-specific parameters beforehand (e.g., by sensing).

The brake-specific data can be input into the electronic unit by the producer of the brake pad or by the producer of the commercial vehicle. When the brake pad is exchanged, the reading and evaluation device determines whether the brake specific data urgently stipulated for safety reasons is fulfilled and which further data is present (e.g. date of manufacture, coefficient of friction, lining area, etc.). Monitoring of the brake pad is now carried out without physical contact and without visual contact. The electronic unit used is also referred to as an RF label, transponder, smart label, tag, etc.

In a preferred configuration, the unit consists of an RFID chip which contains a memory and a processor together with a transmitter unit for signal transmission. The dimensions of an RFID chip are relatively small, so that it can be inserted in the brake pad during manufacture thereof. Alternatively, it might also be bonded to the brake pad at a suitable location.

The spatial disposition of the reading and evaluation device with respect to the electronic unit may be varied. For example, it is provided in a first configuration that the current supply of the electronic unit is effected from an electromagnetic field of the reading and evaluation device. However, with this arrangement the reading and evaluation device must be arranged in direct proximity to the vehicle brake or directly on the vehicle brake. If the power supply from the electromagnetic field is no longer possible because of the distance between the electronic unit and the reading and evaluation device, the electronic unit may also be equipped with a voltage source as its power supply. As a voltage source, a battery has preferential consideration.

In order to receive the signal transmitted by the electronic unit, the receiving and evaluation device is equipped with an antenna. It is especially advantageous if the antenna is installed on the brake caliper or if the brake caliper is configured as an antenna. Alternatively, however, the antenna may be installed on the circuit board of the wear detection system.

There are also various possibilities for arranging the reading and evaluation device. Thus, in preferred configurations it is provided that the reading and evaluation device is installed inside the vehicle brake or in the interior of the vehicle. The arrangement inside the vehicle has the advantage that this position is easily accessible.

Commercial vehicles are also usually fitted with an ABS system. It is therefore also possible for the reading and evaluation device to be integrated in the control unit of an ABS system. Especially in the case of new vehicles, the reading and evaluation device might be installed at the outset in the control unit.

The radio RF labels, transponders, smart labels or tags necessary for the vehicle brake according to the invention are used in so-called RFID (Radio Frequency Identification) systems. To achieve the set object, therefore, the use of the RFID system is also proposed for identifying the pads of a vehicle brake, in particular for a commercial vehicle.

Such a system replaces a bar code, for example.

The invention also creates a brake pad operable with the vehicle brake and brake system.

In a brake system having a vehicle brake of the type described previously, it may be provided in an advantageous design that pad-specific data on the electronic unit of the brake pad can be processed by a control unit of the vehicle brake system, the data including pad-specific parameters such as, at least, the quality attained in production, the lining area or the coefficient of friction, since these parameters influence the braking effect.

In developing this brake system, data on the manufacture itself, such as the date of production, the batch involved, the production location and the like, may also be captured. In the event of quality problems of the producer, the brake pads affected can thereby be identified in a targeted manner. Hitherto, corresponding data has been imprinted on the back plates of the brake pads for this purpose. A disadvantage thereof is that, in the event of an exchange action or recall action, all the brake pads must be removed and inspected. This gives rise to relatively high costs, and in many cases the identification marking is no longer legible. By means of the tag, corresponding data could be input into the reading and evaluation device during installation of the pads and, for example, stored centrally in the vehicle. This storage could take place in the electronic brake system or in an onboard computer. It is advantageous that the readout of an onboard computer renders the individual inspection superfluous. Because of the central data acquisition, a problem does not arise even if the tag fails in operation through overheating of the brake.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a disc brake according to the invention in a partially sectional view but without brake cylinders; and

FIG. 2 shows a brake pad for the disc brake according to an embodiment of the invention in vertical plan.

### DETAILED DESCRIPTION OF THE DRAWINGS

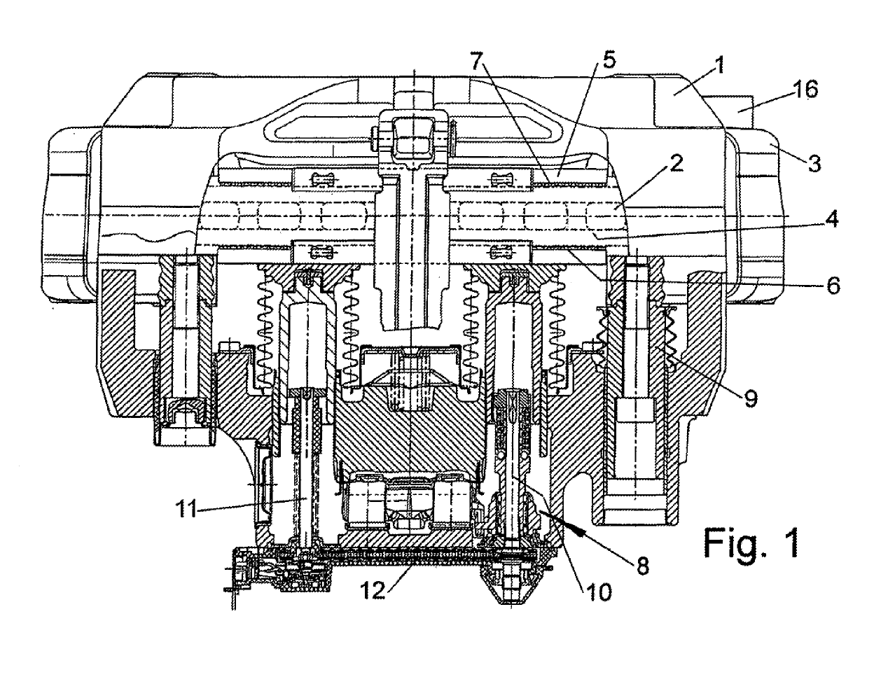

The disc brake represented in FIG. 1 is equipped with a brake caliper 1, which extends around a brake disc 2. This disc brake is also provided with a brake carrier 3. Arranged on each side of the brake disc 2 are brake pad carrier plates 4, 5, to the side of which facing the brake disc 2 the brake pads 6, 7 are fastened. The disc brake is further equipped with a brake application device 8 to mechanically multiply an input force, and a wear adjuster 10 to compensate for wear of the brake pads 6, 7.

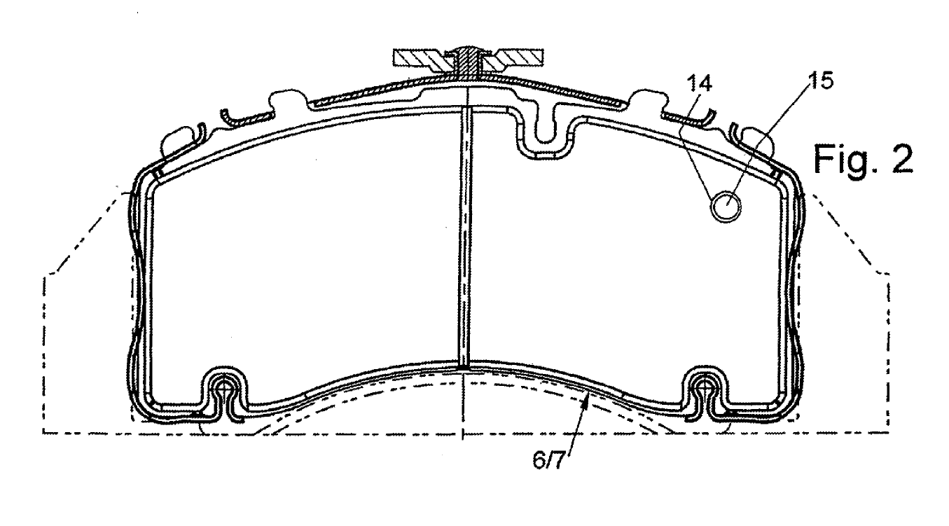

The disc brake has a mounting 9 for the brake caliper 1. The brake application device 8 is further equipped with the wear adjuster 10, a driver 11 and a chain 12. The brake pad 6, 7 shown in FIG. 2 is inserted in a brake pad shaft 13 (represented by dot-dashed lines) of the brake carrier 3. The brake pad 6, 7 consists of a pad carrier (pad carrier plate) which carries a pad material. In the exemplary embodiment illustrated, each brake pad 6, 7 is provided with a recess 14 in which an RFID chip 15 is inserted. This RFID chip 15 consists essentially of a memory for storing brake specific data, a processor and a transmitter unit for transmitting signals to a reading and receiving device 16 by radio. The recess 14 may be provided in the pad material, although the chip yields resiliently in the direction of the pad carrier with respect to the surface facing towards the brake disc 2, so that it remains undamaged as the pad material wears. The recess might also be worked into the pad carrier.

In an alternative construction to that illustrated, the chip 15 forming an electronic component may also be bonded at a suitable location after the manufacture of the brake pad 6, 7.

In the exemplary embodiment illustrated in FIG. 1 the reading and evaluation device 16, which receives signals transmitted by the chip 15, is fastened to the brake caliper 1. The reading and evaluation device 16 is also provided with an antenna.

In an alternative construction to that illustrated, the reading and evaluation device may also be installed at an appropriate location inside the commercial vehicle. Thus it is also possible, especially in the case of new vehicles, that the reading and evaluation device is installed directly in the control unit of an ABS or EBS system, so that this system can process the applicable brake pad specific parameters directly when activating the brakes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle brake, comprising:
a brake application device;
brake pads applied by the brake application device; and
wherein at least one brake pad comprises an electronic unit having an electronic memory for storing at least brake pad-specific data.

2. The vehicle brake according to claim 1, wherein the vehicle brake is one of a disc brake and a drum brake.

3. The vehicle brake according to claim 1, further comprising a reading and evaluation device for data transmittable by the electronic unit, the reading and evaluation device being mounted in a region outside of the brake pad.

4. The vehicle brake according to claim 3, wherein the electronic unit comprises a chip containing memory and a processor, and an antenna for signal transmission.

5. The vehicle brake according to claim 3, wherein the reading and evaluation device comprises an antenna for receiving the transmittable data.

6. The vehicle brake according to claim 4, wherein the antenna is installed on one of:
a caliper of a disc brake and a circuit board of a wear detection system of a disc brake.

7. The vehicle brake according to claim 4, wherein a caliper of the disc brake is designed as the antenna.

8. The vehicle brake according to claim 3, wherein the reading and evaluation device is installed inside one of the vehicle brake and a vehicle having the vehicle brake.

9. The vehicle brake according to claim 8, wherein when the reading and evaluation device is installed in the vehicle, the reading and evaluation device is integrated in a control unit of an ABS system of the vehicle.

10. A brake pad of a vehicle brake, the brake pad comprising:
a pad carrier plate;
pad material mounted on the pad carrier plate; and
an electronic unit comprising an electronic memory for storing at least brake pad-specific data.

11. The brake pad according to claim 10, wherein the electronic unit is arranged in the pad material.

12. A brake system, comprising:
a vehicle brake, the vehicle brake comprising a brake application device and brake pads applied by the brake application device, wherein at least one brake pad comprises an electronic unit having an electronic memory for storing at least brake pad-specific data;
a control unit of the brake system, the control unit processing the brake pad-specific data;
wherein the pad-specific data includes pad-specific parameters influencing a braking effect of the vehicle brake.

13. The brake system according to claim 12, wherein the pad-specific parameters comprise at least one of a pad quality, a pad lining area, and a pad coefficient of friction, which parameters are attained during manufacture of the brake pad.

14. The brake system according to claim 12, wherein the vehicle brake is one of a disc brake and a drum brake.

15. The brake system according to claim 12, wherein the control unit processes additional parameters supplied by the electronic unit of the brake pad.

16. The brake system according to claim 15, wherein the additional parameters comprise at least one of a quality of the brake pad, a manufacturer of the brake pad, a date of production of the brake pad, data relating to manufacturer of the brake pad, a batch production of the brake pad and a production location of the brake pad.
